(19) United States
(12) Patent Application Publication
(10) Pub. No.: US 2019/0171802 A1
(43) Pub. Date: Jun. 6, 2019

(54) ELECTRONIC DEVICE AND CONTROLLING METHOD THEREOF

(71) Applicant: Samsung Electronics Co., Ltd., Suwon-si (KR)

(72) Inventors: Xuan Hoa LE, Hanoi City (VN); Van Vinh VU, Hai Phong City (VN)

(21) Appl. No.: 16/032,916

(22) Filed: Jul. 11, 2018

(30) Foreign Application Priority Data
Dec. 1, 2017 (KR) 10-2017-0164019

(51) Int. Cl. G06F 21/32; H04L 9/32; G06F 3/041; G06F 3/0488

(52) U.S. Cl. CPC G06F 21/32; G06F 3/0488; G06F 3/0416; H04L 9/3226

(57) ABSTRACT

An electronic device is provided. The electronic device according to an example includes an input unit, a storage configured to store reference information that is used for authentication, and a processor configured to, based on authentication information for encrypting contents being input, identify whether the authentication information is identical to the reference information, and the encrypted contents include the authentication information and time information related to provision of the encrypted contents.

### CROSS-REFERENCE TO RELATED APPLICATIONS AND CLAIM OF PRIORITY

This application claims priority from Korean Patent Application No. 10-2017-0164019, filed on Dec. 1, 2017, in the Korean Intellectual Property Office, the disclosure of which is incorporated herein by reference in its entirety.

### TECHNICAL FIELD

The disclosure relates to an electronic device which encrypts content or decrypts encrypted content and a controlling method thereof.

### BACKGROUND

Electronic devices such as smart phones, portable computers and the like can create, display and share documents including contents which require security.

In general, software for encryption must be purchased separately in order to protect such contents, which could be a burden on the users of the electronic devices in terms of cost.

In addition, in order to encrypt non-secured contents, it is common that the contents are encrypted by software for encryption after a document which contains important contents is created or stored. Accordingly, there is a problem in that the contents are vulnerable in terms of security while the contents are being created or before the contents are stored.

### SUMMARY

An aspect of the disclosure relates to an electronic device capable of encrypting contents or decrypting encrypted contents in real time through software downloaded from an external server and a controlling method thereof.

An electronic device according to certain embodiments includes an input unit, a storage configured to store reference information which is used for authentication, and a processor configured to, based on authentication information for encrypting contents being input, identify whether the authentication information is identical to the reference information, and based on the authentication information being identical to the reference information, encrypt contents input through the input unit in real time, and the encrypted contents include the authentication information and time information related to provision of the encrypted contents.

The electronic device may further include a display, and the time information may be information regarding a time during which the encrypted content is displayed on the display after being decrypted according to the authentication information.

The processor may encrypt the contents based on an encryption mode selected from a plurality of encryption modes, and the plurality of encryption modes may include a global encryption mode for encrypting all of the input contents and a local encryption mode for encrypting some contents which satisfy a predetermined condition from among the input contents.

The predetermined condition may be at least one of a condition in which a specific keyword is included and a condition in which a touch input is input.

The authentication information may be at least one of a personal identification number (PIN), password, fingerprint, signature, face recognition information, iris recognition information, voice recognition information, or an email account.

The processor, based on authentication information for decrypting the encrypted contents being input, may identify whether the input authentication information is identical to authentication information which is used to encrypt the contents, and based on the input authentication information being identical to the authentication information which is used to encrypt the contents, may obtain the time information by decrypting the encrypted contents and provides the decrypted contents based on the obtained time information.

The electronic device may further include a display, and the processor may display the decrypted contents on the display for a predetermined time based on the time information, and remove the displayed contents on the display after the predetermined time elapses.

The processor may remove the displayed contents on the display, and realign remaining contents to fill an area where the contents are displayed.

According to certain embodiments, there is provided a method of controlling an electronic device which stores reference information used for authentication, the method including, based on authentication information for encrypting contents being input, identifying whether the authentication information is identical to the reference information, and based on the authentication information being identical to the reference information, encrypting contents input through the input unit in real time, and the encrypted contents include the authentication information and time information related to provision of the encrypted contents.

The time information may comprise information regarding a time during which the encrypted content is displayed on the display after being decrypted according to the authentication information.

The encrypting may include encrypting the contents based on an encryption mode selected from a plurality of encryption modes, and the plurality of encryption modes may include a global encryption mode for encrypting all of the input contents and a local encryption mode for encrypting some contents which satisfy a predetermined condition from among the input contents.

The predetermined condition may be at least one of a condition in which a specific keyword is included and a condition in which a touch input is input.

The authentication information may be at least one of PIN, password, fingerprint, signature, face recognition information, iris recognition information, voice recognition information, or an email account.

The method may further include, based on authentication information for decrypting the encrypted contents being input, identifying whether the input authentication information is identical to authentication information which is used to encrypt the contents, based on the input authentication information being identical to the authentication information which is used to encrypt the contents, obtaining the time information by decrypting the encrypted contents, and providing the decrypted contents based on the obtained time information.

Providing, according to certain embodiments of the method, may include displaying the decrypted contents on the display for a predetermined time based on the time information, and removing the displayed contents on the display after the predetermined time elapses.

Providing, according to certain embodiments of the method may include removing the displayed contents on the display, and realigning remaining contents to fill an area where the contents are displayed.

According to the above-described various exemplary embodiments, authentication may be performed for a legitimate user through input authentication information, and contents may be encrypted in real time, thereby enhancing security.

In addition, the various exemplary embodiments of the present disclosure may be implemented only by driving software which is downloaded from an external server and thus, user convenience can be enhanced.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates aspects of an encryption and decryption system according to certain embodiments;

FIG. 2 illustrates, in block diagram format, a configuration of an electronic device according to some embodiments;

FIG. 3 illustrates an encryption unit according to some embodiments;

FIG. 4 illustrates a decryption unit according to certain embodiments;

FIG. 5 illustrates a configuration of a display control section according to various embodiments;

FIG. 6 illustrates operations of a process of encrypting a content in real time according to various embodiments;

FIG. 7 illustrates operations of a process of removing encrypted content and aligning contents after a predetermined time elapses according to certain embodiments;

FIG. 8 illustrates operations of an automatic removal mode in which encrypted content is removed automatically after a predetermined time elapses according to some embodiments;

FIG. 9 illustrates aspects of a process in which encrypted content is removed and remaining contents are realigned;

FIG. 10 illustrates operations of an encrypting method in an electronic device according to various embodiments; and

FIG. 11 illustrates operations of a decrypting method in an electronic device according to certain embodiments.

### DETAILED DESCRIPTION

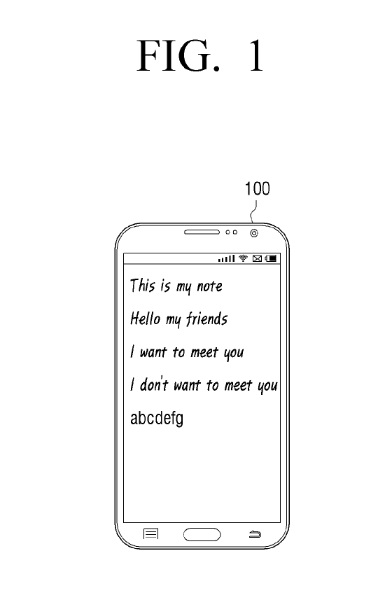

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Below, exemplary embodiments will be described in detail with reference to the accompanying drawings. In describing exemplary embodiments, detailed description of relevant known functions or components may be omitted if it would obscure the description of the subject matter. In addition, the exemplary embodiments may be changed in various forms, and therefore, the technical scope is not limited to the following exemplary embodiments. Rather, these exemplary embodiments are provided to make the present disclosure thorough and complete.

Unless explicitly described otherwise, the term ‘including’ will be understood to imply the inclusion of a component, but not the exclusion of any other components. Further, various elements and areas in the drawings are schematically drawn. Therefore, the technical ideas are not limited by a relative size or interval drawn in the accompanying drawings.

In addition, the expression ‘at least one of a, b, and c’ may be interpreted as at least one of ‘a’, ‘b’, ‘c’, ‘a and b’, ‘a and c’, ‘b and c’, and ‘a, b and c.’

Hereinafter, embodiments of the present disclosure will be explained with reference to the drawings.

FIG. 1 illustrates aspects of an encryption and decryption system according to some embodiments.

According to certain embodiments, an electronic device 100 has the function of encrypting a content and decrypting an encrypted content. The electronic device 100, for example, may be embodied as a smartphone. However, the electronic device 100 may be any device which is capable of driving an application including the functions of encryption and decryption. For example, the electronic device 100 may be embodied as a tablet PC, a laptop computer, a PC, and the like.

In the non-limiting example of FIG. 1, the electronic device 100 is a smartphone, but this is only an example and the electronic device 100 is not limited thereto.

Meanwhile, according to certain embodiments, the electronic device 100 may encrypt a content which is input (for example, a text in FIG. 1) in real time. In addition, when an encrypted content is received, the electronic device 100 may perform authentication to decrypt the content, and provide the decrypted content only for a predetermined time based on time information related to provision of the content included in the content. Hereinafter, various embodiments will be provided in detail along with the corresponding drawings.

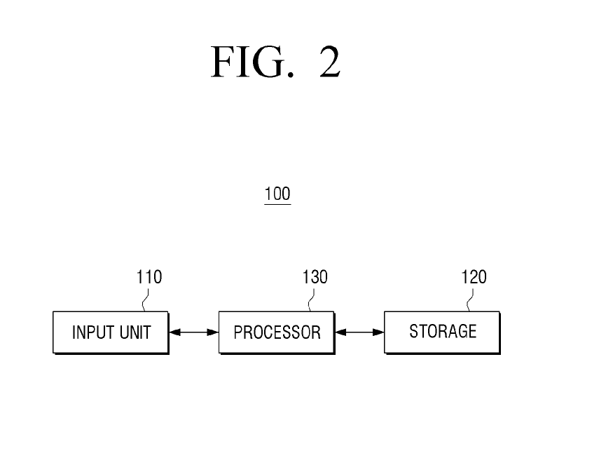

FIG. 2 illustrates a configuration of an electronic device according to some embodiments.

Referring to the non-limiting example of FIG. 2, the electronic device 100 includes an input unit 110, a storage 120 and a processor 130.

The input unit 110 may receive an input of a content. The input content may be written by a user in real time or may be prepared in advance. The content which is input to the input unit 110 may include a text, an image or combination of texts and images, but are not limited thereto. Here, the content which is prepared in advance may be received from the storage 120, an external storage (not illustrated) which can be physically connected to an input port, such as a USB device, or an external storage (not illustrated) which is remotely connected to the electronic device 100 via a communication network such as the Internet or a cloud-based platform.

The input unit 110 may be embodied as a keyboard, a touch pad, a mouse, or a device which recognizes a voice, but is not limited thereto.

The storage 120 may store various data, programs or applications which are used to drive/control the electronic device 100. The storage 120 may store control programs to control the electronic device 100 and the processor 130, applications which are initially provided or downloaded from outside, database, or related data.

In particular, the storage 120 may store applications which encrypt and decrypt contents according to various embodiments and reference information which is used for authentication to perform encryption or decryption.

Here, the reference information may be a PIN, password, fingerprint, signature, face recognition information, iris recognition information, voice recognition information or reference information regarding an email account.

The storage 120 may be embodied as an internal memory included in the processor 130 such as ROM, RAM, etc., or may be embodied as a memory which is separate from the processor 130. In this case, the storage 120 may be embodied in the form of a memory embedded in the electronic device 100 or in the form of a memory which is removable from the electronic device 100 depending on the purpose of data storage. For example, if data is used for driving the electronic device 100, the data is stored in the memory embedded in the electronic device 100, and if data is used for extended function of the electronic device 100, the data may be stored in the memory which is removable from the electronic device 100. Meanwhile, the memory embedded in the electronic device 100 may be embodied in the form of non-volatile memory, volatile memory, HDD, SDD, and the like.

The processor 130 controls overall operations of the electronic device 100.

The processor 130 according to various embodiments may be embodied as a digital signal processor (DSP) which processes digital signals, microprocessor, or Time controller (TCON), but is not limited thereto. The processor 130 may include one or more units from among central processing unit (CPU), Micro Controller Unit (MCU), Micro Processing Unit (MPU), controller, application processor (AP), communication processor (CP), and ARM processor, or may be defined as the corresponding term. In addition, the processor 130 may be embodied as System on Chip (SoC) or Large Scale Integration (LSI) including a processing algorithm, or in the form of Field Programmable Gate Array (FPGA).

According to certain embodiments, when authentication information to encrypt a content is input, the processor 130 may identify whether the authentication information is consistent with reference information which is used for authentication. Here, the authentication information may be at least one of a PIN, password, fingerprint, signature, face recognition information, iris recognition information, voice recognition information or an e-mail account, but is not limited thereto.

When it is identified that the authentication information is consistent with the reference information, the processor 130 may encrypt a content input through the input unit 110 in real time. Specifically, if it is identified that the authentication information input from a user is consistent with the reference information, the processor 130 may convert an off mode in which it is impossible to perform encryption of a content to an on mode in which it is possible to perform encryption of a content. However, if the authentication information is not consistent with the reference information, the processor 130 may maintain the off mode.

According to another example, transitioning between the on mode and off mode may be performed by simply toggling an on mode switch and an off mode switch provided on the display without comparing the authentication information and the reference information.

Meanwhile, if an input content is a content which is written in advance, the processor 130 may encrypt the written content.

The encrypted content may include authentication information and time information related to provision of the encrypted content. Here, the time information may be information regarding a time during which the encrypted content is displayed on the display after being decrypted according to the authentication information (not illustrated). For example, if the time information included in an encrypted content is 10 minutes, the corresponding content may be decrypted and displayed only for 10 minutes.

The processor 130 may perform encryption of a content based on an encryption mode which is selected from among a plurality of encryption modes. Specifically, if a mode is converted to an on mode based on comparison between authentication information and reference information, the processor 130 may encrypt a content based on an encryption mode which is selected from a plurality of encryption modes.

Here, the plurality of encryption modes may include a global encryption mode for encrypting all of the content which are input and a local encryption mode for encrypting some of the contents which satisfy predetermined conditions.

Here, the predetermined conditions may be at least one of a condition in which a specific keyword is included and a condition in which a touch input is received. The touch input may include a touch input by a user's hand and a touch input by a stylus pen.

For example, if the selected encryption mode is a global encryption mode, the processor 130 may encrypt all of texts, images and the like which are input in real time. In addition, if contents are prepared in advance is input through the input unit 110, the processor 130 may encrypt all of the texts, images and the like which are prepared in advance.

Alternatively, if the selected encryption mode is a local encryption mode, and a predetermined condition is a condition in which a keyword of “patent” is input, the processor 130 may encrypt a sentence or a paragraph including “patent”, or may encrypt a sentence or a paragraph including not only the keyword of “patent” but also a keyword related to “patent.” The keyword related to a specific keyword may be pre-stored in the storage 120, or may be received from an external server. Alternatively, if a predetermined condition is a condition in which a stylus pen is used, the processor 130 may encrypt all of the texts, images and the like which are written by a stylus pen.

If a specific content which is prepared in advance is input, the processor 130 may identify whether an encrypted content is included in the corresponding content. As an encrypted content includes authentication information, the processor 130 may identify whether an encrypted content is included in the corresponding content based on whether there is authentication information or not.

If it is identified that an encrypted content is included in the corresponding content, the processor 130 may provide a user with a feedback informing that there is the encrypted content.

Here, the feedback may comprise the display of a pop-up window or a predetermined icon, or may comprise haptic feedback such as vibrating the electronic device 100. However, this is only an example, and the feedback may be provided by outputting specific sound or voice or emitting a light from an LED light source.

According to certain embodiments, feedback may include information for requesting an input of authentication information to decrypt data which includes an encrypted content from a user. For example, the processor 130 may display at least one of a text, an image and combination thereof for requesting an input of authentication information on a displayed pop-up window.

If authentication information to decrypt an encrypted content is input, the processor 130 may identify whether the input authentication information is consistent with authentication information which is used for encryption of the content. The authentication information used for encryption of the content refers to authentication information which is input by a user to encrypt the content.

If the input authentication information is consistent with the authentication information which is used for encryption of the content, the processor 130 may obtain time information by decrypting the encrypted content and provide the decrypted content based on the obtained time information.

Specifically, the processor 130 may display the decrypted content on a display (not illustrated) for a predetermined time based on the time information.

In some embodiments, the time information comprises information regarding a time during which the encrypted content is displayed on the display after being decrypted according to the authentication information (not illustrated). For example, if the time information included in the encrypted content is 10 minutes, the processor 130 may obtain the time information of 10 minutes and display the encrypted content only for 10 minutes.

If data including an encrypted content is executed and displayed in the state where authentication information is not input, the processor 130 may display only the content which is not encrypted excluding the encrypted content.

If a predetermined time has elapsed, the processor 130 may remove the displayed content from the display (not illustrated). The processor 130 may remove the displayed content sequentially or gradually. The removed content may return to the content in the encrypted state and stored in the storage 120 or deleted from the storage 120.

The processor 130 may remove the displayed content from the display (not illustrated) and realign the remaining content on the display such that the display is filled with the remaining content. For example, suppose a case in which five lines of texts are displayed continuously on the display as illustrated in FIG. 1. If the content to be removed is the text on the fourth line out of the five lines, the processor 130 may realign the texts such that the fourth line where the text is removed can be filled with the text on the fifth line. As a result, four lines of texts may be displayed continuously. Accordingly, the readability of the remaining content can be improved and the space of the display (not illustrated) can be used more efficiently.

An application capable of performing encryption and decryption functions according to some embodiments, for example, may be downloaded from an external server via a communication network. The processor 130 may drive such an application.

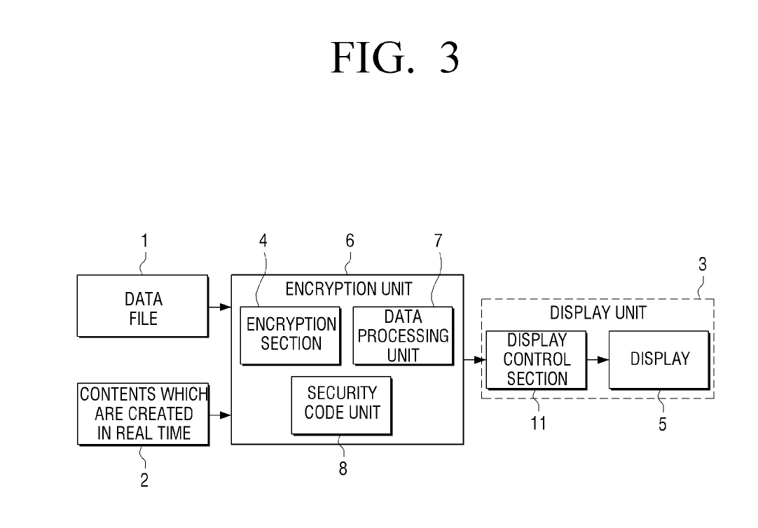

FIG. 3 illustrates an encryption unit according to some embodiments.

An encryption unit 6 illustrated in the non-limiting example of FIG. 3 may be implemented as the above-described processor 130.

Referring to FIG. 3, the encryption unit 6 may receive a data file which is written in advance or a content 2 which is written in real time through an input device. The data file 1 or the content 2 written in real time may include a text, an image or combination thereof, but is not limited thereto.

According to some embodiments, the data file 1 may be received from an external storage such as a USB device physically connectable to an input port of the electronic device 100 or a storage remotely connected to the electronic device 100 via a communication network such as Internet, a cloud-based platform.

Here, the input device may be implemented as a keyboard, a touch pad, a mouse or a device for recognizing voice. Here, the touch pad may receive an input of content through a user hand or a stylus pen.

The encryption unit 6 may encrypt input content sources 1, 2 which are input through an input device in real time according to an encryption method of an encryption section 4.

Specifically, the encryption unit 6 may operate in an on mode in which input content sources 1, 2 which are input through an input device can be encrypted in real time according to the encryption method of the encryption section 4. Alternatively, the encryption unit 6 may operate in an off mode in which the input content sources 1, 2 cannot be encrypted. Here, the encryption method of the encryption section 4 may include a global encryption mode and a local encryption mode, which will be described later.

If authentication information to encrypt a content input from a user is input, a security code unit 8 may identify whether authentication information which is input to perform the operation of the encryption unit 6 is consistent with reference information which is stored. Here, the reference information may be stored in an application including encryption and decryption functions according to certain embodiments or stored in the electronic device 100 in advance.

The authentication information, for example, may be one of a PIN, password, fingerprint, signature, face recognition information, iris recognition information, voice recognition information or an e-mail account. However, this is only an example, and the authentication information is not limited thereto.

If the authentication information input from a user is consistent with the reference information, the encryption unit 6 may be converted to be in an on mode. On the other hand, if the authentication information is not consistent with the reference information, the encryption unit 6 may maintain an off mode.

According to other embodiments, the on mode and the off mode may be changed to one another by simply toggling an on mode switch and an off mode switch provided on the display 5 without comparing the authentication information and the reference information.

If the encryption mode is converted to be in the on mode, the encryption unit 6 may perform encryption of a content based on an encryption mode which is selected from a plurality of encryption modes. Here, the plurality of encryption modes may include a global encryption mode in which all of the input contents are encrypted and a local encryption mode in which some of the contents which satisfy a predetermined condition from among the input contents are encrypted.

Here, the predetermined condition may be at least one of a condition in which a specific keyword is included and a condition in which a touch input is input. The touch input may include a touch input by a user's hand and a touch input by a stylus pen.

For example, the selected encryption mode is a global encryption mode, the encryption unit 6 may encrypt all of the texts, images and the like which are input in real time. In addition, the encryption unit 6 may encrypt all texts, images and the like which are written in advance.

Alternatively, if the selected encryption mode is a local encryption mode, and a predetermined condition is a condition in which a keyword of “patent” is input, the encryption unit 6 may encrypt a sentence including “patent”, or may encrypt a sentence including not only the keyword of “patent” but also a keyword related to “patent.” The keyword related to a specific keyword may be pre-stored in the electronic device 100, or may be received from an external server. Alternatively, if a predetermined condition is a condition in which a stylus pen is used, the encryption unit 6 may encrypt all of the texts, images and the like which are written by a stylus pen.

If data including a content which is encrypted by the encryption unit 6 is generated, the encryption unit 6 may include authentication information to decrypt the content and time information related to provision of the encrypted content. By including the authentication information and the time information in the data, the encryption unit 6 may control an external approach to the encrypted content and control the method of processing the decrypted content (for example, a display time of the decrypted content). Here, the time information may be information regarding a time during which the encrypted content is displayed on the display 5 after being decrypted according to the authentication information. For example, if the time information included in an encrypted content is 10 minutes, the corresponding content may be decrypted and displayed only for 10 minutes.

Here, the authentication information may be at least one of a PIN, password, fingerprint, signature, face recognition information, iris recognition information, voice recognition information, or an email account.

The method of displaying data by the display unit 3 after the data is decrypted by a decryption unit 10 or encrypted by the encryption unit 6 may be defined by time information.

For example, if data including an encrypted content and a non-encrypted content is decrypted, the decrypted content may be displayed in a secure and controlled manner.

Specifically, whether a content in data is encrypted or not encrypted may be determined based on authentication information included in the data. Accordingly, the display unit 3 may display a non-encrypted content without limitation and an encrypted data only for a predetermined time based on time information included in the data. In a case where an encrypted content is removed on the display after a predetermined time elapses, the encrypted content may be removed instantly or gradually, and the area where the content is removed may become a blank space.

According to other embodiments, a non-encrypted content may be highlighted or may be displayed on a pop-up window. However, this is only an example, and an encrypted content and a non-encrypted content may be distinguished from one another in various methods.

Meanwhile, when encrypted data is shared by an external electronic device, the method of providing an encrypted content may be determined based on authentication information included in the data and time information related to provision of the encrypted content in the data. If an application including the above-described encryption and decryption functions is operated in an external electronic device, the external electronic device, when authentication information is input, may acquire time information by comparing the input authentication information with the authentication information which is used for encrypting the content and decrypting the encrypted content, and provide the decrypted content based on the acquired time information as described above.

According to various embodiments, if an encrypted content is decrypted in the decryption unit 10 to be changed to a general content and thus, does not require decryption, the content may be displayed for a predetermined time after the decryption and the corresponding content may be removed from a storage (not illustrated) after the predetermined time elapses. However, this is only an example, and an encrypted content may be decrypted and displayed, and then encrypted again after a predetermined time elapses.

The content encrypted by the encryption unit 6 may be stored by a data processing unit 7. Here, the data processing unit 7 may include a data storage, for example, a flash memory to store the content encrypted by the encryption unit 6.

The data storage of the data processing unit 7 may be separated from a storage (not illustrated) which is used to store a non-encrypted content. An encrypted content may be stored in the data storage of the data processing unit 7 and may be transmitted to a display control unit 18 of a display control section 11 which will be described later.

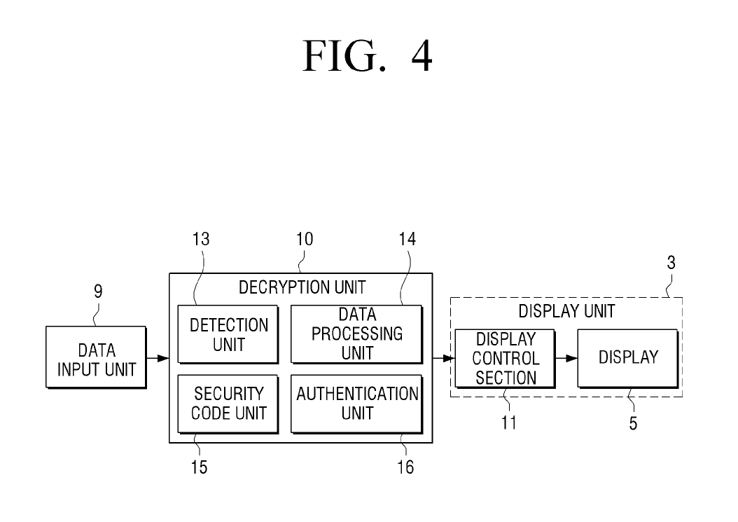

FIG. 4 illustrates a decryption unit according to some embodiments.

The decryption unit 10 illustrated in the non-limiting example of FIG. 4 may be implemented as the processor 130.

Not only the data in the data storage 120 of the electronic device 100 but also the data generated and provided by an external device may be provided to the decryption unit 10 through a data input unit 9.

A detection unit 13 of the decryption unit 10 may identify whether an encrypted content is included in the data provided to the decryption unit 10.

If the detection unit 13 identifies that at least part of an encrypted content in the provided data, a feedback for informing the presence of the encrypted content may be provided to a user.

Here, feedback may be provided, for example, by displaying a pop-up window or a predetermined icon, or may be provided as haptic feedback, such as by vibrating the electronic device 100. However, this is only an example, and the feedback may be provided by outputting specific sound or voice or emitting a light from an LED light source

According to various embodiments, feedback may include information for requesting an input of authentication to decrypt data which includes an encrypted content from a user. For example, the pop-up window displayed on the display 5 may display a text for requesting an input of authentication information.

Subsequently, if the authentication information is input, an authentication unit 16 may identify whether the decryption unit 10 may decrypt data including the encrypted content based on the input authentication information. Specifically, the authentication unit 16 may compare the input authentication information with authentication information included in the data including the encrypted content to see whether the information is consistent with each other, and if the information is consistent with each other, identify that the decryption unit 10 may decrypt the encrypted content.

However, if authentication information which is consistent with the authentication information included in the encrypted content is not input to the decryption unit 10, the authentication unit 16 may not decrypt the input content by inactivating the operation of the decryption unit 10.

If it is identified that the decryption unit 10 may decrypt the encrypted content, the data processing unit 14 may decrypt the encrypted content and transmit the decrypted data to the display unit 3 including the display control section 11 and the display 5.

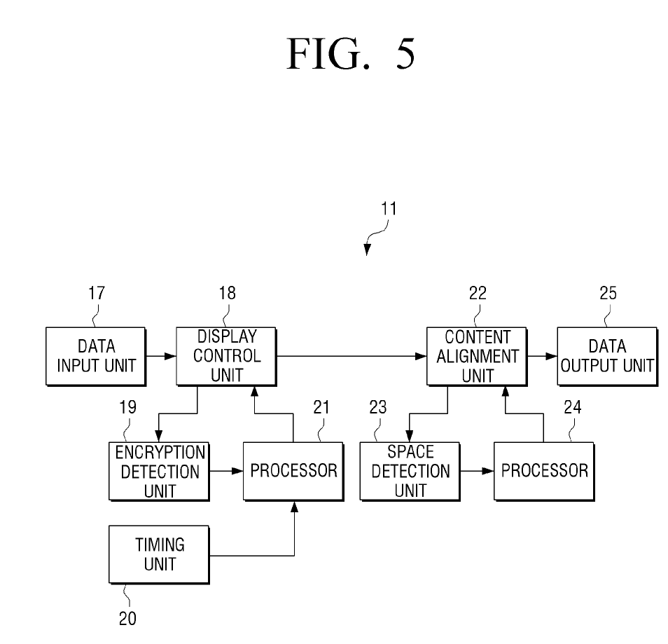

FIG. 5 illustrates of a display control section according to certain embodiments.

Referring to the non-limiting example of FIG. 5, the display control section 11 may include a data input unit 17, a display control unit 18, an encryption detection unit 19, a timing unit 20, a processor 21, a content arrangement unit 22, a space detection unit 23, a processor 24, and a data output unit 25.

The data transmitted from the encryption unit 6 or the decryption unit 10 may be transmitted to the display control unit 18 through the data input unit 17. Alternatively, the data may be transmitted from a data storage of an external device to the display control unit 18 through the data input unit 17.

The display control unit 18 may determine the method of displaying a decrypted content on the display 5 based on the authentication information included in the encrypted content and time information related to provision of the encrypted content.

The encryption detection unit 19 may identify whether an encrypted content is included in data which is input.

If it is identified that an encrypted content is included in the input data, the display control unit 18 may classify an encrypted content and a non-encrypted content based on authentication information included in the data.

The display control unit 18 may display an encrypted data on the display 5 for a predetermined time based on the time information included in the data, and after the predetermined time elapses, the space where the encrypted content has been displayed may be replaced with a blank space.

The timing unit 20 may acquire time information included in the input data and provide the time information to the processor 21. The processor 21 may identify whether a predetermined time elapses since an encrypted content has been displayed based on the provided time information, and if the predetermined time elapses, remove the encrypted content from the display 5.

Subsequently, the remaining contents may be rearranged. Specifically, the content arrangement unit 22 may rearrange a display screen so that a blank space is removed and non-encrypted contents are displayed sequentially.

In the non-limiting example of FIG. 5, the content arrangement unit 22 may include the space detection unit 23 which identifies a blank space in a content and the processor 24 which calculates the method of arranging non-encrypted contents on the display 5 sequentially.

The space detection unit 23 may identify a blank space where an encrypted content is removed after a predetermined time elapses. The space detection unit 23 may transmit information regarding the identified space to the processor 24. The processor 24 calculates the area of the blank space so that the blank space where the encrypted content is removed could be filled with the remaining contents. For example, consider the case in which five lines of text are displayed on the display 5 continuously as illustrated in FIG. 1. If the content to be removed is the text on the fourth line from among the five lines of text, the processor 24 may calculate the method of filling the blank space where the text on the fourth line are removed with the text on the fifth line. The processor 24 may transmit information regarding the calculated area of the blank space and the method of rearranging contents to the content arrangement unit 22.

The content arrangement unit 22 may control the data output unit 25 to rearrange the contents on the display 5 based on the information transmitted from the processor 24, and the rearranged contents may be displayed through the display 5.

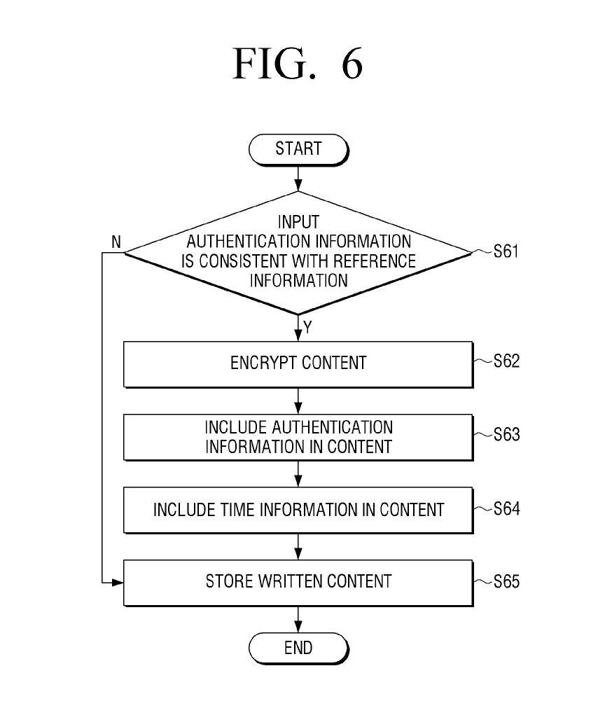

FIG. 6 illustrates operations of a process of encrypting a content in real time according to some embodiments.

Referring to the non-limiting example of FIG. 6, when a content is including a text, an image and combination thereof is created and authentication information is input, the security code unit 8 may identify whether the input authentication information is consistent with reference information which is used for authentication (S61). In this non-limiting example, the authentication information may be at least one of a PIN, password, fingerprint, signature, face recognition information, iris recognition information, voice recognition information or an email account, but is not limited thereto. The security code unit 8 may identify in real time whether authentication information is input.

If the authentication information is consistent with the reference information, the encryption unit 6 may encrypt a content which is input in real time (S62). The encryption unit 6 may perform encryption regarding the content based on an encryption mode which is selected from among a plurality of encryption modes.

Here, the plurality of encryption modes may include a global encryption mode in which all of the input contents are encrypted and a local encryption mode in which a part of contents which satisfy a predetermined condition from among the input contents are encrypted.

Here, the predetermined condition may be at least one of a condition in which a specific keyword is input and a condition in which a touch input is received. The touch input may include a touch input by a user's hand and a touch input by a stylus pen.

For example, if the selected encryption mode is a local encryption mode and a predetermined condition is a condition in which a stylus pen is used, all of the texts, the images, etc. which are written by a stylus pen may be encrypted.

Authentication information may be automatically included in an encrypted content (S63). Specifically, authentication information may be included in an encrypted content based on a user setting, and the user setting may be one of a global encryption mode and a local encryption mode.

For example, if the mode is set to the global encryption mode, the authentication information may be related to all contents which are written. Alternatively, if the mode is set to the local encryption mode, the authentication information may be related to the contents which are written according to a predetermined contention. For example, if data consisting of non-encrypted contents only is received, the non-encrypted contents are not related to authentication information and thus, authentication information may not be required from a user.

The electronic device 100 may include time information indicating a time during which an encrypted content is displayed in the content (S64). An encrypted content and a non-encrypted content may be stored as data (S65). Subsequently, the data including such a content, for example, may be shared in an external electronic device freely through a social network via Internet. The shared data in the external electronic device may be received by a data input unit of the external electronic device and decrypted by a decryption unit.

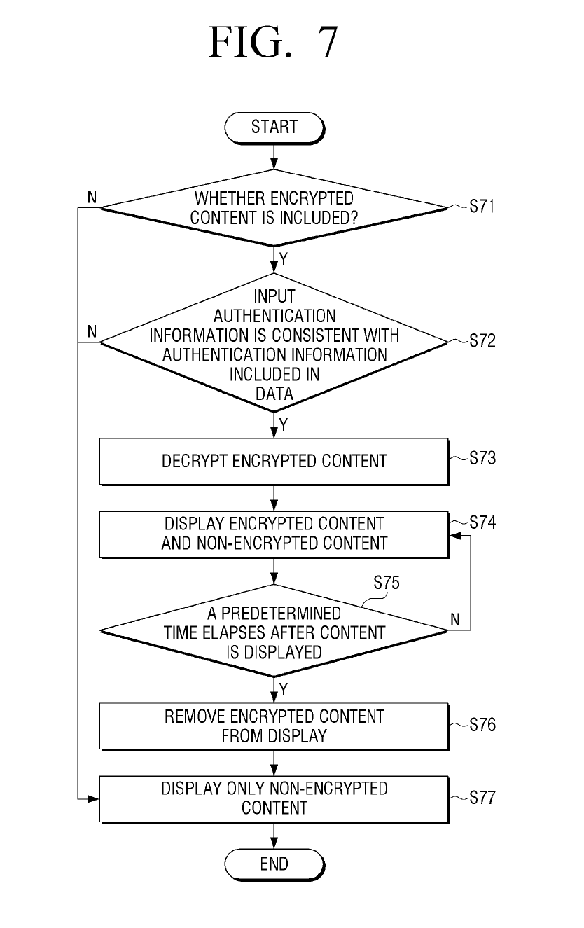

FIG. 7 illustrates operations of a process for removing an encrypted content after a predetermined time elapses and rearranging contents according to various embodiments.

Referring to the non-limiting example of FIG. 7, the detection unit 13 of the decryption unit 10 may detect whether an encrypted content is included in data received (S71).

If it is identified that an encrypted content is included in the received data (S71—Y), authentication information may be received in order to decrypt the encrypted content. Specifically, if the detection unit 13 identifies that an encrypted content is included in the received data, a user may be informed of the presence of the encrypted content and provided with a feedback requesting an input of authentication information.

If authentication information is input, the authentication unit 16 of the decryption unit 10 may identify whether the input authentication information is consistent with the authentication information which is used for encryption of the content, that is, the authentication information included in the encrypted content (S72).

If the authentication unit 16 identifies the input authentication information is consistent with the authentication information which is used for encryption of the content (S72—Y), the data processing unit 14 may decrypt the encrypted content (S73).

The display unit 3 may display an encrypted content and a non-encrypted content on the display 5 (S74).

The display unit 3 may identify whether a predetermined time elapses since an encrypted content is displayed on the display 5 (S75). If it is identified that a predetermined time elapses since an encrypted content has been displayed on the display 5 (S75—Y), the display unit 3 may remove the encrypted content from the display 5 (S76). Subsequently, the display unit 3 may display a non-encrypted content only (S77).

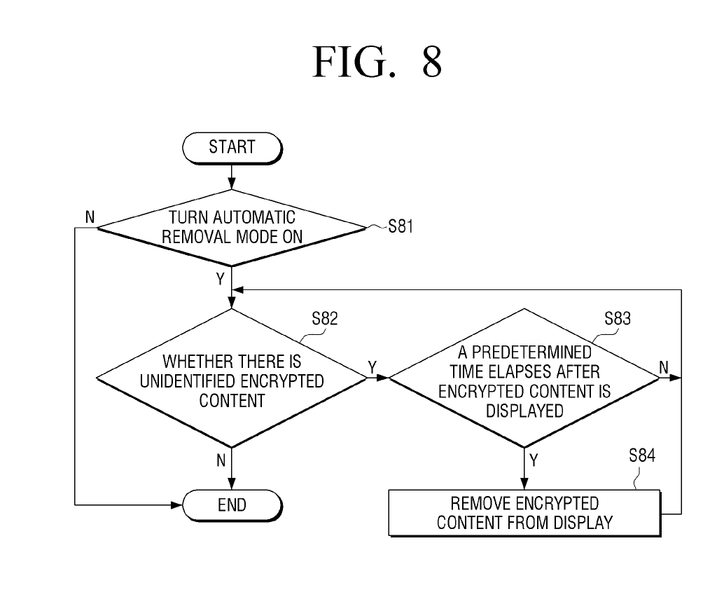

FIG. 8 illustrates operations of an automatic removal mode in which an encrypted content is automatically removed after a predetermined time elapses according to certain embodiments.

In the non-limiting example of FIG. 8, automatic removal mode refers to a mode in which an encrypted content is decrypted and displayed on the display 5 for a predetermined time, and if the predetermined time elapses, the content is removed automatically.

The automatic removal mode may be selectively turned on or turned off according to a user setting (S81). If it is identified that the automatic removal mode is turned on (S81—Y), the encryption detection unit may identify whether there is an encrypted mode which is not identified (S82).

If there is an unidentified content (S82—Y), the processor 21 may identify whether a predetermined time elapses since an encrypted content has been displayed based on predetermined time information provided from the timing unit 20 (S83). If it is identified that the predetermined time elapses since the encrypted content has been displayed (S83—Y), the processor 21 may remove the encrypted content from the display 5 (S84).

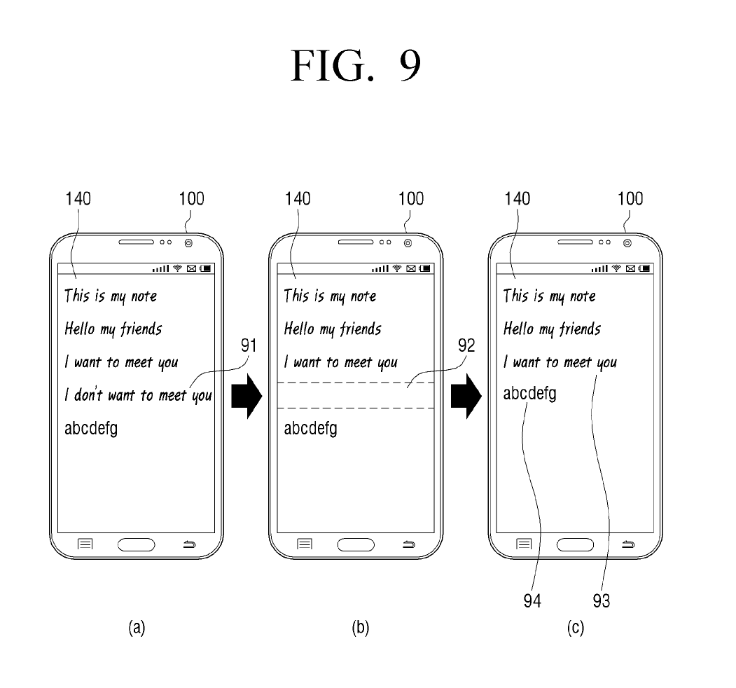

FIG. 9 illustrates three scenes, labeled (a), (b) and (c) of a process of removing an encrypted content and rearranging the remaining contents.

Referring to the non-limiting example of FIG. 9, in scene (a) an encrypted content 91 and a non-encrypted content may be displayed on the display 140. Specifically, the display control unit 18 may display the encrypted content 91 and the non-encrypted content on the display 140.

Referring to the non-limiting example of FIG. 9, in scene (b), if a predetermined time elapses, the display control unit 18 may remove the encrypted content 91 based on authentication information included in the encrypted content and time information related to provision of the encrypted content. The area 92 where the encrypted content is removed may be a blank space.

Referring to the non-limiting example of FIG. 9, in scene (c), the space detection unit 23 of the electronic device 100 may identify the location of the area where the encrypted content is removed to become a blank space, and the content arrangement unit 22 may rearrange the remaining non-encrypted contents. Specifically, the content arrangement unit 22 may remove the blank space and rearrange the contents such that non-encrypted contents are displayed on the display screen continuously. For example, as the encrypted content is removed, the text “I want to meet you” 93 and “abcdefg” 94 displayed on the display 140 may be displayed continuously as illustrated in FIG. 9C. Accordingly, not only the readability of the remaining contents is improved, but also the space of the display 140 may be used more efficiently.

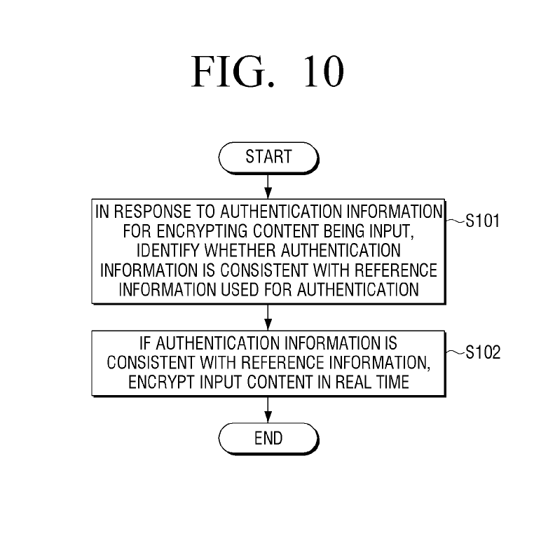

FIG. 10 illustrates operations of an encrypting method in an electronic device according to some embodiments.

When authentication information to encrypt a content is input, the electronic device 100 may identify whether the authentication information is consistent with reference information which is used for authentication reference (S101). Here, the authentication information may be at least one of a PIN, password, fingerprint, signature, face recognition information, iris recognition information, voice recognition information or an email account, but is not limited thereto.

If the authentication information is consistent with the reference information, the electronic device 100 may encrypt an input content in real time. Specifically, if it is identified that the authentication information input from a user is consistent with the reference information, the electronic device 100 may convert an off mode where encryption of a content is not possible to an on mode where encryption of a content is possible. On the other hand, if the authentication information is not consistent with the reference information, the electronic device 100 may maintain the off mode.

As each step has been described in detail, further description will not be provided.

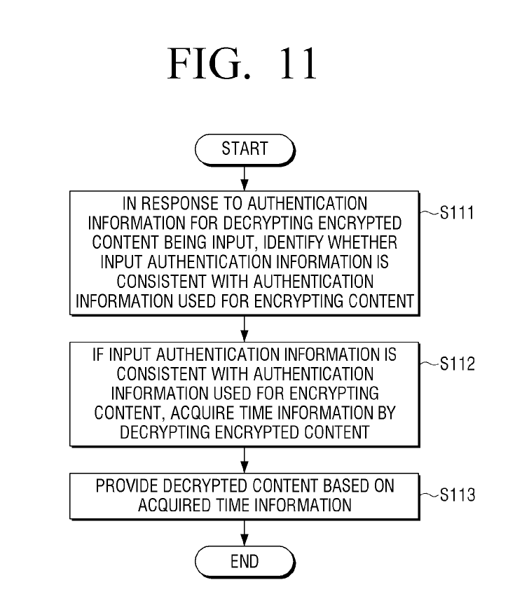

FIG. 11 illustrates operations of a decrypting method in an electronic device according to various embodiments.

If authentication information to decrypt an encrypted content is input, the electronic device 100 may identify whether the input authentication information is consistent with the authentication information which is used for encryption (S111). The authentication information which is used for encryption of a content refers to the authentication information which is input from a user for encryption of a content.

If the input authentication information is consistent with the authentication information which is used for encryption of a content, the electronic device 100 may decrypt the encrypted content and acquire time information (S112).

Subsequently, the electronic device 100 may provide the decrypted content based on the acquired time information (S113). Specifically, the electronic device 100 may display the decrypted content for a predetermined time based on the time information.

An application capable of performing encryption and decryption functions according to certain embodiments, for example, may be downloaded from an external server through a network.

If an application according to some embodiments is executed in a plurality of electronic devices and an encrypted content generated in one electronic device is transmitted to another electronic device, the another electronic device may decrypt the encrypted content.

Meanwhile, at least some of the methods according to the above various embodiments may be implemented in the form of an application which can be installed in an existing electronic device.

In addition, at least some of the methods according to the above various embodiments may be performed through an embedded server provided in an electronic device or an external server of an electronic device.

Meanwhile, the above-described various embodiments may be implemented in a recording medium which can be read by a computer or a similar device using software, hardware or a combination thereof. In some cases, the embodiments described herein may be implemented by a processor itself. According to software implementations, the embodiments such as the procedures and functions described herein may be implemented in separate software modules. Each of the software modules may perform one or more of the functions and operations described herein.

Meanwhile, computer instructions for performing operations according to the various embodiments may be stored in a non-transitory computer-readable medium. The computer instructions stored in such a non-transitory computer-readable medium may allow a specific device to perform the operations according to the various embodiments when executed by a processor.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as CD, DVD, hard disk, Blu-ray disk, USB, memory card, ROM, etc.

The foregoing exemplary embodiments and advantages are merely exemplary and are not to be construed as limiting the present disclosure. The present teaching can be readily applied to other types of apparatus. Also, the description of the exemplary embodiments of the present disclosure is intended to be illustrative, and not to limit the scope of the claims, and many alternatives, modifications, and variations will be apparent to those skilled in the art.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
an input unit;
a storage configured to store reference information that is used for authentication; and
a processor configured to:
based on authentication information for encrypting contents being input, identify whether the authentication information is identical to the reference information, and
based on the authentication information being identical to the reference information, encrypt contents input through the input unit in real time,
wherein the encrypted contents include the authentication information and time information related to provision of the encrypted contents.

2. The electronic device as claimed in claim 1, further comprising:
a display,
wherein the time information is information regarding a time during which the encrypted content is displayed on the display after being decrypted according to the authentication information.

3. The electronic device as claimed in claim 1, wherein:
the processor is configured to encrypt the contents based on an encryption mode selected from a plurality of encryption modes, and
the plurality of encryption modes include a global encryption mode for encrypting the input contents and a local encryption mode for encrypting a portion of the input contents that satisfy a predetermined condition.

4. The electronic device as claimed in claim 3, wherein the predetermined condition is at least one of a condition in which a specific keyword is included or a condition in which a touch input is input.

5. The electronic device as claimed in claim 1, wherein the authentication information comprises at least one of a PIN, password, fingerprint, signature, face recognition information, iris recognition information, voice recognition information, or email account.

6. The electronic device as claimed in claim 1, wherein the processor is further configured to:
based on authentication information for decrypting the encrypted contents being input, identify whether the input authentication information s identical to authentication information that is used to encrypt the contents, and
based on the input authentication information being identical to the authentication information that is used to encrypt the contents, obtain the time information by decrypting the encrypted contents and provides the decrypted contents based on the obtained time information.

7. The electronic device as claimed in claim 6, further comprising:
a display,
wherein the processor is configured to display the decrypted contents on the display for a predetermined time based on the time information, and remove the displayed contents from the display after the predetermined time elapses.

8. The electronic device as claimed in claim 7, wherein the processor is configured to realign remaining contents to fill an area where the removed contents were displayed.

9. A controlling method of an electronic device that stores reference information used for authentication, the method comprising:
based on authentication information for encrypting contents being input, identifying whether the authentication information is identical to the reference information; and
based on the authentication information being identical to the reference information, encrypting contents input through an input unit in real time,
wherein the encrypted contents include the authentication information and time information related to provision of the encrypted contents.

10. The method as claimed in claim 9, wherein the time information is information regarding a time during that the encrypted content is displayed on a display after being decrypted according to the authentication information.

11. The method as claimed in claim 9, wherein:
encrypting the contents comprises encrypting the contents based on an encryption mode selected from a plurality of encryption modes, and
the plurality of encryption modes include a global encryption mode for encrypting the input contents and a local encryption mode for encrypting some a portion of the input that satisfy a predetermined condition.

12. The method as claimed in claim 11, wherein the predetermined condition is at least one of a condition in which a specific keyword is included or a condition in which a touch input is input.

13. The method as claimed in claim 9, wherein the authentication information comprises at least one of a PIN, password, fingerprint, signature, face recognition information, iris recognition information, voice recognition information, or email account.

14. The method as claimed in claim 9, further comprising:
based on authentication information for decrypting the encrypted contents being input, identifying whether the input authentication information is identical to authentication information that is used to encrypt the contents;
based on the input authentication information being identical to the authentication information that is used to encrypt the contents, obtaining the time information by decrypting the encrypted contents; and
providing the decrypted contents based on the obtained time information.

15. The method as claimed in claim 14, wherein providing the decrypted contents comprises:
displaying the decrypted contents on the display for a predetermined time based on the time information; and
removing the displayed contents on the display after the predetermined time elapses.

16. The method as claimed in claim 15, wherein providing the decrypted contents further comprises realigning remaining contents to fill an area where the removed contents were displayed.

17. A non-transitory computer-readable medium comprising program code, which when executed by a processor, causes an electronic device to:
store reference information that is used for authentication,
based on authentication information for encrypting contents, the encrypted contents including the authentication information and time information related to provision of the encrypted contents, being input, identify whether the authentication information is identical to the reference information, and
based on the authentication information being identical to the reference information, encrypt contents input through an input unit of the electronic device in real time.

18. The non-transitory computer-readable medium of claim 17, wherein the time information is information regarding a time during which the encrypted content is displayed on a display of the electronic device, after being decrypted according to the authentication information.

19. The non-transitory computer-readable medium of claim 17, further comprising program code, which when executed by the processor, cause the electronic device to:
encrypt the contents based on an encryption mode selected from a plurality of encryption modes,
wherein the plurality of encryption modes include a global encryption mode for encrypting the input contents and a local encryption mode for encrypting a portion of the input contents that satisfy a predetermined condition.

20. The non-transitory computer-readable medium of claim 19, wherein the predetermined condition is at least one of a condition in which a specific keyword is included or a condition in which a touch input is input at the electronic device.
